(19) United States
(12) Patent Application Publication
(10) Pub. No.: US 2019/0362025 A1
(43) Pub. Date: Nov. 28, 2019

(54) PERSONALIZED QUERY FORMULATION FOR IMPROVING SEARCHES

(71) Applicant: Microsoft Technology Licensing, LLC, Redmond, WA (US)

(72) Inventors: Runfang Zhou, Sunnyvale, CA (US); Ajit Paul Singh, San Francisco, CA (US); Xianren Wu, San Jose, CA (US); Anish Ramdas Nair, Fremont, CA (US); Linzhen Xuan, San Jose, CA (US); Kevin Chuang, San Francisco, CA (US); Bikramjit Singh, San Jose, CA (US); Da Teng, Sunnyvale, CA (US)

(21) Appl. No.: 15/990,145

(22) Filed: May 25, 2018

(51) Int. Cl. G06F 17/30; G06N 99/00; G06Q 10/10

(52) U.S. Cl. CPC G06F 17/30867; G06Q 10/1053; G06N 99/005; G06F 17/3056

(57) ABSTRACT

A machine is configured to improve a search engine. For example, the machine generating, for a user, one or more search facets using one or more machine learning algorithms. The generating of the search facets is based on a user profile associated with the user and one or more similar user profiles. The machine receives an identifier of the user from a client device. The machine causes a display of one or more selectable identifiers of the one or more search facets in a user interface of the client device associated with the user. The machine receives, from the client device, an indication of a selection of the one or more selectable identifiers of the one or more search facets. The machine causes a display of one or more job descriptions in the user interface based on a search performed using the one or more search facets.

### TECHNICAL FIELD

The present application relates generally to systems, methods, and computer program products for personalized query formulation to improve a search engine.

### BACKGROUND

Some personalized searches involve analyzing the user characteristics against a corpus of possible results to find the best options for a user. For example, a job search may generate different results for different users depending on their background, education, experience, etc. Sometimes, finding similarities between users is helpful because if a user has shown interest in a job, a user with similar characteristics may also be interested in that job, too.

However, the number of users of an online system may be in the millions, and the categories of data associated with the users (e.g., educational institutions, current jobs, etc.) may also be into the thousands or millions. Finding similarities among all these users may be a computationally expensive proposition given the large amount of data and possible categories, thereby resulting in a technical problem of excessive consumption of the electronic resources of a computer system performing the search.

### BRIEF DESCRIPTION OF THE DRAWINGS

Some embodiments are illustrated by way of example and not limitation in the figures of the accompanying drawings, in which:

FIG. 1 is a network diagram illustrating a client-server system, according to some example embodiments;

FIG. 2 illustrates the training and use of a machine-learning program, according to some example embodiments;

FIG. 3 is a block diagram illustrating components of a machine learning system, according to some example embodiments;

FIG. 4 is a flowchart illustrating a method for personalized query formulation to improve searches, according to some example embodiments;

FIG. 5 is a flowchart illustrating a method for personalized query formulation to improve searches, and representing step 402 of the method illustrated in FIG. 4 in more detail, according to some example embodiments;

FIG. 6 is a flowchart illustrating a method for personalized query formulation to improve searches, and representing step 512 of the method illustrated in FIG. 5 in more detail, according to some example embodiments;

FIG. 7 is a flowchart illustrating a method for personalized query formulation to improve searches, and representing step 402 of the method illustrated in FIG. 5 in more detail, according to some example embodiments;

FIG. 8 is a flowchart illustrating a method for personalized query formulation to improve searches, and representing step 402 of the method illustrated in FIG. 7 in more detail, according to some example embodiments;

FIG. 9 is a flowchart illustrating a method for personalized query formulation to improve searches, and representing step 402 of the method illustrated in FIG. 7 in more detail, according to some example embodiments; and

FIG. 10 is a block diagram illustrating components of a machine, according to some example embodiments, able to read instructions from a machine-readable medium and perform any one or more of the methodologies discussed herein.

### DETAILED DESCRIPTION

Example methods and systems for personalized query formulation to improve searches are described. In the following description, for purposes of explanation, numerous specific details are set forth to provide a thorough understanding of example embodiments. It will be evident to one skilled in the art, however, that the present subject matter may be practiced without these specific details. Furthermore, unless explicitly stated otherwise, components and functions are optional and may be combined or subdivided, and operations may vary in sequence or be combined or subdivided.

Digital content is ubiquitous in multiple avenues of an online service—as a part of a flagship feed, interest feed, emails, notifications, and other products. An example of an online service is a social network service (e.g., LinkedIn® professional networking services). Despite the omnipresence of digital content items on an online service, a technical problem associated with providing relevant digital content to users of the online service is the automatic formulating of personalized queries to retrieve digital content that is relevant to particular users. For example, in the context of a social networking service (hereinafter also “SNS”) that provides professional networking services (e.g., recruiter or job-finding services), many users (e.g., job applicants) lack knowledge of the diverse lexicon of titles and skills, or the competitive landscape of their industry. This lack of knowledge may lead to inefficient use of the electronic resources of a computer system performing searches requested by the users.

A machine learning system may provide a technical solution to the technical problem of formulating the right query to retrieve relevant jobs aligned with the users' professional skills and experiences. For instance, the machine learning system accesses user profiles of the users of the SNS, and identifies users of the SNS who are similar to each other based on one or more attributes in their user profiles. The machine learning system then accesses user profile data of a particular user and user profile data of similar users, and uses the accessed user data as training data for one or more machine learning algorithms to generate personalized queries for each user. For example, attribute values pairs generated from the particular user profile and a similar user profile, and the affinity score values associated with the attribute value pairs are used as input to train one or more machine learning models to generate search facets (e.g., search queries) that are relevant to the particular user. Accordingly, using the many features included in a user profile, and the affinity values determined for the features, the machine learning system can generate the right job search queries for the particular user using the trained one or more machine learning models.

A generated personalized query may be a search facet recommendation generated, by the machine learning system, for a particular user based on analysis of the data of the particular user (e.g., member profile data, activity and behavior data, social graph data, etc.) and of the data of one or more users identified to be similar to the particular user. The machine learning system, based on the personalized queries, may identify relevant jobs for the users. The machine learning system (or another system) may cause a user interface that includes personalized queries, relevant jobs identified based on the personalized queries, or both, to be presented to a user via a client device of the user.

In some example embodiments, the machine learning system generates personalized queries for a user before the user logs in to the SNS, and causes presentation of the generated personalized queries in a user interface after the user logs in to the SNS and before the user searches for jobs on the SNS. The user can select (e.g., click on) a query, and get job descriptions fetched based on the selected query. The user does not need to type the query.

The user may also select an identifier of a personalized query to be deleted (e.g., to not be used in a job search for the user). The machine learning system, in some example embodiments, uses the indication of the selected identifier of the personalized query as input for further training of the one or more machine learning models. This further training enhances the one or more machine learning models. Other actions by the user with respect to the suggested search facets (or suggested job descriptions) may server as further input into the one or more machine learning models, and further improve the machine learning models.

In various example embodiments, the machine learning system identifies relevant jobs descriptions for a user before the user logs in to the SNS, and causes presentation of the identified relevant job descriptions in a user interface after the user logs in to the SNS and before the user searches for jobs on the SNS.

In some example embodiments, the similar profiles to be used by the machine learning system, as described above, are further selected based on a number of profile views that exceeds a certain threshold value within a certain time frame (e.g., one week, two weeks, etc.). This basis for selection of the similar profiles indicates the selected similar profiles have been sufficiently validated by peer reviews, thus eliminating noise from bogus profiles, and mitigating the scalability challenge while preserving sufficient statistics. For example, an online social service has around 500 million users with corresponding user profiles. Most user profiles are not viewed by other users. The system may select around 100 million profiles as a particular data set based on each user profile in the particular data set being viewed by other users at least once in the past two weeks. The user profiles in the particular data set are considered to be high quality profiles with good peer reviews.

In some example embodiments, the features (hereinafter also “attributes”) included in user profiles are used for training machine learning models (e.g., deep learning machine training models) for generating search facets for performing personalized searched that identify relevant jobs for users of the online service. In machine learning, a feature is an individual measurable property or characteristic of a phenomenon being observed. For example, in the context of the online system, features of similar user profiles are inputs to machine learning models that generate search facets relevant to a particular user, and identify jobs that the particular user may be interested in.

In various example embodiments, using expressive features in deep learning models to understand content, as well as users' preferences for content not only provide a richer experience to the user, but also enhances machine learning tools for digital content processing and understanding. Further, content representation learning improves data processing efficiency and data storage.

Deep learning refers to a class of techniques used to model a response by generating complex data transformations and abstractions using multi-layer neural networks. Deep learning can support a vast array of applications, ranging from response prediction, feature generation, natural language understanding, speech or image recognition, and understanding.

Deep learning techniques may be used in modeling a user's response when a machine learning system recommends one or more search facets to a user to assist a user with a job search. Often a user's response to a search facet recommendation is a function of a relevance of the search facet to the user's interests, context, or timing of the presentation of the digital content.

Many relevance problems aim at identifying, predicting, or searching something for the user, such as finding a job that would interest the user. In some example embodiments, relevance helps identify the things that are appropriate for the user based on the user features and one or more types of similarities. For example, a job search engine may find jobs that would be interesting for the user because “similar” users have explored those jobs. However, finding similarities among users, among users and jobs, users and articles, users and advertisements, etc., are complex problems, especially in a system where there could be millions of users, jobs, articles, and advertisements.

In machine learning, categorical features are those features that may have a value from a finite set of possible values. In some example embodiments, categorical features include skills of the user, title of the user, industry of the user, company of the user, and educational institutions attended by the user.

In some example embodiments, similarities may be identified by converting categorical values to vectors (a process referred to herein as “embedding”) and then utilizing tools well-suited for operating on vectors. However, a simple vector definition where each value of the category is assigned a position within the vector (a representation sometimes called “bag of words”) results in very large vectors with very sparse values (e.g., a single 1 among 35,000 values). Because such vectors are difficult to work with, reducing the size of the vectors, in some instances, is important.

In some example embodiments, obtaining vectors with an embedded semantic meaning is important because similarity analysis is simplified using the embedded semantic meaning. For example, two vectors being close to each other indicates that the two vectors represent two categorical values that are similar.

A machine learning system may utilize embeddings to provide a lower dimensional representation of different features, and can learn the embeddings along with the model parameters. In certain example embodiments, a deep learning model for response prediction is characterized using three “macro” layers: (1) an input layer which takes in the input features, and fetches embeddings for the input, (2) one or more intermediate (or hidden) layers which introduces nonlinear neural net transformations to the inputs, and (3) a response layer which transforms the final results of the intermediate layers to the prediction. The response layer may be a Sigmoid function.

According to some example embodiments, the machine learning system generates, for a user of an online system, one or more search facets using one or more machine learning algorithms. The generating of the one or more search facets is based on the features in a user profile associated with the user and based on the features of one or more similar user profiles identified to be similar to the user profile. The one or more search facets may be stored in a database record in association with a user identifier of the user of the online system. The features in a particular profile may include a current job title, previous job titles, skill identifiers, identifiers of educational institutions, location identifiers, etc.

The machine learning system receives an identifier (e.g., one or more login credentials) of the user of the online system from a client device associated with the user. The machine learning system causes a display of one or more selectable identifiers of the one or more search facets in a user interface of the client device associated with the user. The causing of the display of the one or more selectable identifiers may be based on the receiving of the identifier of the user. The machine learning system receives, from the client device, an indication of a selection of the one or more selectable identifiers of the one or more search facets. The machine learning system causes a display of one or more job descriptions in the user interface of the client device associated with the user based on a search performed using the one or more search facets. The causing of the display of the one or more job descriptions is performed in response to the receiving, from the client device, of the indication of the selection of the one or more selectable identifiers of the one or more search facets.

In some example embodiments, to generate the one or more search facets the machine learning system accesses the user profile of the user of the online system, and extracts a first set of attribute values from the user profile. An attribute value included in the first set corresponds to an attribute included in the user profile. The machine learning system accesses a similar user profile that is identified to be similar to the user profile of the user. The similar user profile is associated with a further user (e.g., another user, a second user, etc.) of the online system. The machine learning system extracts a second set of attribute values from the similar user profile. The attribute value included in the second set corresponds to an attribute included in the similar user profile. The machine learning system generates one or more pairs of attribute values based on the first set of attribute values and the second set of attribute values. Each of the one or more pairs of attribute values includes a first attribute value from the first set of attribute values and a second attribute value from the second set of attribute values. For each of the one or more pairs of attribute values, the machine learning system generates an attribute affinity score value (hereinafter also “affinity score value”) that represents an affinity between the first attribute value from the first set of attribute values and the second attribute value from the second set of attribute values.

In various example embodiments, the generating of the attribute affinity score value includes: computing an attribute co-occurrence count of co-occurrences of the first attribute value and the second attribute value included in a particular pair of attribute values in the user profile and in the one or more similar user profiles; normalizing the attribute co-occurrence count, the normalizing resulting in the attribute affinity score value; and associating the attribute affinity score value with the particular pair of attribute values in a database record.

For example, utilizing an application for identifying similar profiles, the machine learning system identifies, for user A associated with the title “Software Engineer” in the user profile of user A, a set of similar profiles with the titles “Software Engineer,” “Software Developer,” or both. The machine learning system may generate a pair of entities, e.g., <Software Engineer, Software Developer>, based on the titles “Software Engineer” and “Software Developer.” The machine learning system determines an affinity score associated with the pair <Software Engineer, Software Developer> based on computing the number of times (e.g., a co-occurrence value or count) the title “Software Engineer” and the title “Software Developer” appear in the user profile and in the set of similar profiles, and normalizes the co-occurrence value. The more co-occurrences of a pair of attributes in the similar profiles (e.g., in the profile of user A and a similar profile of a user B), the more similar the attributes are (e.g., the higher the affinity score value associated with the pair including the two attributes).

The normalizing may include dividing the co-occurrence value of a first pair of attributes (e.g., the pair <Software Engineer, Software Developer>) by a sum of the co-occurrence value of the first pair of attributes and one or more further co-occurrence values of one or more further pairs of attributes (e.g., the pair <Software Engineer, University of Washington>, the pair <Software Engineer, Microsoft>, the pair <Software Engineer, San Francisco>, the pair <Software Engineer, Ruby on Rails>, the pair <Redding, San Francisco>, etc.). The result of the normalizing of the co-occurrence value is the attribute affinity score value associated with the first pair of attributes. The result of the normalizing operation is a value between 0.00 and 1.00.

In various embodiments, the affinity score value is computed using the following formulae:

G-Test value of (tᵢ,tₖ)=(N_{i, k})/(S−1))(ΣᵢN_{i,j}−N_{i,k}),

Sigmoid normalize to (0,1)

$$\frac{1}{1 + {e}^{- G - Test}}$$

In statistics, G-tests are likelihood-ratio or maximum likelihood statistical significance tests. In the above formulae, tᵢ is a first attribute, “Software Engineer,” and tₖ is a second attribute, “Software Developer,” of an attribute pair.

N_{i,k} is the total number of attribute pairs (tᵢ,tₖ).
S is the total number of titles related to attribute tᵢ (e.g., “Software Engineer”).
N_{i,j} is the total number of attribute pairs (tᵢ,tⱼ).
ΣⱼNi,j means N_{i, 1+} N_{i, 2+} . . . +N_{i,s}.

The machine learning system may rank, for the particular user, a plurality of pairs of attributes based on their associated affinity score values. In some instances, the machine learning system selects one or more attribute pairs that have affinity score values that are equal to or exceed a certain affinity threshold value. The machine learning system then identifies, based on the selected one or more attribute pairs, one or more attributes included in the one or more attribute pairs as one or more search facets to be used in job searched for the particular user. The one or more search facets are associated with the user in a database record.

Based on determining that the user has logged in to the online system, the machine learning system may present the one or more search facets in a user interface of a client device associated with the user.

According to some example embodiments, the machine learning system facilitates various functions associated with a recruiter service. For example, a recruiter provides the job title “Software Engineer” as input in a user interface of a client device. The machine learning system automatically select a location (e.g., San Jose) and displays an identifier of the location in the user interface. The selection of the location is based on the affinity score value associated with the <Software Engineer, San Jose> attribute pair being equal to or exceeding a certain affinity threshold value.

If the affinity score value of the <Software Engineer, San Jose> pair is equal or higher than certain affinity threshold value, there may be many Software Engineer jobs in San Jose. For example, the affinity score value for <Software Engineer, San Jose> is 0.75, and for <Software Engineer, Fargo N.D.> is 0.10. This means the co-occurrence of <Software Engineer, San Jose> is very much higher in similar profiles than <Software Engineer, Fargo N.D>.

In some example embodiments, where a pair of attributes <ABC, DEF> includes attribute ABC and attribute DEF, and the associated affinity score of the pair of attributes meets or exceeds an affinity threshold value, the machine learning system displays an identifier of one of the attributes of the pair (e.g., ABC or DEF) in response to an input of the other attribute (e.g., DEF or ABC). To continue the example above, the machine learning system displays an identifier of the location “San Jose” in the user interface in response to the recruiter providing the job title “Software Engineer” as input in the user interface of the client device. According to another example, one or more identifiers of attributes included in various pairs of attributes associated with affinity score values that meet or exceed an affinity threshold value are automatically displayed in a user interface of a client device based on determining that correct user authentication data was provided to log in to an online system.

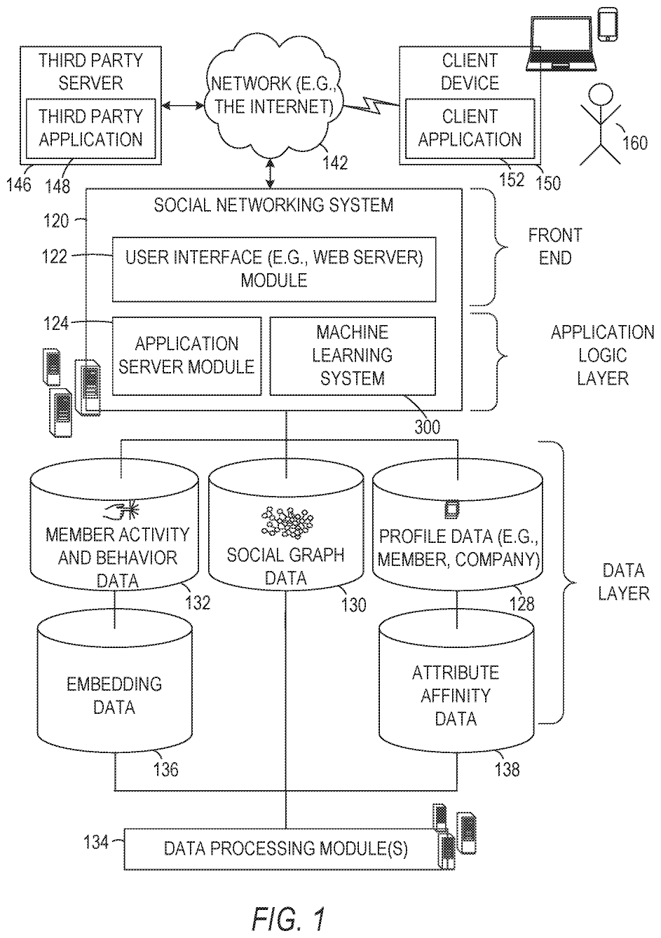

An example method and system for personalized query formulation to improve searches may be implemented in the context of the client-server system illustrated in FIG. 1. As illustrated in FIG. 1, the machine learning system 300 is part of the social networking system 120. As shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, a skilled artisan will readily recognize that various additional functional modules and engines may be used with a social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end layer consists of a user interface module(s) (e.g., a web server) 122, which receives requests from various client-computing devices including one or more client device(s) 150, and communicates appropriate responses to the requesting device. For example, the user interface module(s) 122 may receive requests in the form of Hypertext Transport Protocol (HTTP) requests, or other web-based, application programming interface (API) requests. The client device(s) 150 may be executing conventional web browser applications and/or applications (also referred to as “apps”) that have been developed for a specific platform to include any of a wide variety of mobile computing devices and mobile-specific operating systems (e.g., iOS™, Android™, Windows® Phone).

For example, client device(s) 150 may be executing client application(s) 152. The client application(s) 152 may provide functionality to present information to the user and communicate via the network 142 to exchange information with the social networking system 120. Each of the client devices 150 may comprise a computing device that includes at least a display and communication capabilities with the network 142 to access the social networking system 120. The client devices 150 may comprise, but are not limited to, remote devices, work stations, computers, general purpose computers, Internet appliances, hand-held devices, wireless devices, portable devices, wearable computers, cellular or mobile phones, personal digital assistants (PDAs), smart phones, smart watches, tablets, ultrabooks, netbooks, laptops, desktops, multi-processor systems, microprocessor-based or programmable consumer electronics, game consoles, set-top boxes, network PCs, mini-computers, and the like. One or more users 160 may be a person, a machine, or other means of interacting with the client device(s) 150. The user(s) 160 may interact with the social networking system 120 via the client device(s) 150. The user(s) 160 may not be part of the networked environment, but may be associated with client device(s) 150.

As shown in FIG. 1, the data layer includes several databases, including a database 128 for storing data for various entities of a social graph. In some example embodiments, a “social graph” is a mechanism used by an online service, such as an online social networking service (e.g., provided by the social networking system 120), for defining and memorializing, in a digital format, relationships between different entities (e.g., people, employers, educational institutions, organizations, groups, etc.). Frequently, a social graph is a digital representation of real-world relationships. Social graphs may be digital representations of online communities to which a user belongs, often including the members of such communities (e.g., a family, a group of friends, alums of a university, employees of a company, members of a professional association, etc.). The data for various entities of the social graph may include member profiles, company profiles, educational institution profiles, as well as information concerning various online or offline groups. Of course, with various alternative embodiments, any number of other entities may be included in the social graph, and as such, various other databases may be used to store data corresponding to other entities.

Consistent with some embodiments, when a person initially registers to become a member of the social networking service, the person is prompted to provide some personal information, such as the person's name, age (e.g., birth date), gender, interests, contact information, home town, address, the names of the member's spouse and/or family members, educational background (e.g., schools, majors, etc.), current job title, job description, industry, employment history, skills, professional organizations, interests, and so on. This information is stored, for example, as profile data in the database 128.

Once registered, a member may invite other members, or be invited by other members, to connect via the social networking service. A “connection” may specify a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member connects with or follows another member, the member who is connected to or following the other member may receive messages or updates (e.g., content items) in his or her personalized content stream about various activities undertaken by the other member. More specifically, the messages or updates presented in the content stream may be authored and/or published or shared by the other member, or may be automatically generated based on some activity or event involving the other member. In addition to following another member, a member may elect to follow a company, a topic, a conversation, a web page, or some other entity or object, which may or may not be included in the social graph maintained by the social networking system. With some embodiments, because the content selection algorithm selects content relating to or associated with the particular entities that a member is connected with or is following, as a member connects with and/or follows other entities, the universe of available content items for presentation to the member in his or her content stream increases. As members interact with various applications, content, and user interfaces of the social networking system 120, information relating to the member's activity and behavior may be stored in a database, such as the database 132. An example of such activity and behavior data is the identifier of an online ad consumption event associated with the member (e.g., an online ad viewed by the member), the date and time when the online ad event took place, an identifier of the creative associated with the online ad consumption event, a campaign identifier of an ad campaign associated with the identifier of the creative, etc.

The social networking system 120 may provide a broad range of other applications and services that allow members the opportunity to share and receive information, often customized to the interests of the member. For example, with some embodiments, the social networking system 120 may include a photo sharing application that allows members to upload and share photos with other members. With some embodiments, members of the social networking system 120 may be able to self-organize into groups, or interest groups, organized around a subject matter or topic of interest. With some embodiments, members may subscribe to or join groups affiliated with one or more companies. For instance, with some embodiments, members of the online service may indicate an affiliation with a company at which they are employed, such that news and events pertaining to the company are automatically communicated to the members in their personalized activity or content streams. With some embodiments, members may be allowed to subscribe to receive information concerning companies other than the company with which they are employed. Membership in a group, a subscription or following relationship with a company or group, as well as an employment relationship with a company, are all examples of different types of relationships that may exist between different entities, as defined by the social graph and modeled with social graph data of the database 130. In some example embodiments, members may receive digital communications (e.g., advertising, news, status updates, etc.) targeted to them based on various factors (e.g., member profile data, social graph data, member activity or behavior data, etc.)

The application logic layer includes various application server module(s) 124, which, in conjunction with the user interface module(s) 122, generates various user interfaces with data retrieved from various data sources or data services in the data layer. With some embodiments, individual application server modules 124 are used to implement the functionality associated with various applications, services, and features of the social networking system 120. For example, an ad serving engine showing ads to users may be implemented with one or more application server modules 124. According to another example, a messaging application, such as an email application, an instant messaging application, or some hybrid or variation of the two, may be implemented with one or more application server modules 124. A photo sharing application may be implemented with one or more application server modules 124. Similarly, a search engine enabling users to search for and browse member profiles may be implemented with one or more application server modules 124. Of course, other applications and services may be separately embodied in their own application server modules 124. As illustrated in FIG. 1, social networking system 120 may include the machine learning system 300, which is described in more detail below.

Further, as shown in FIG. 1, a data processing module 134 may be used with a variety of applications, services, and features of the social networking system 120. The data processing module 134 may periodically access one or more of the databases 128, 130, 132, 136, or 138, process (e.g., execute batch process jobs to analyze or mine) profile data, social graph data, member activity and behavior data, embedding data, affinity indicator data, or digital content items and metadata, and generate analysis results based on the analysis of the respective data. The data processing module 134 may operate offline. According to some example embodiments, the data processing module 134 operates as part of the social networking system 120. Consistent with other example embodiments, the data processing module 134 operates in a separate system external to the social networking system 120. In some example embodiments, the data processing module 134 may include multiple servers, such as Hadoop servers for processing large data sets. The data processing module 134 may process data in real time, according to a schedule, automatically, or on demand.

Additionally, a third party application(s) 148, executing on a third party server(s) 146, is shown as being communicatively coupled to the social networking system 120 and the client device(s) 150. The third party server(s) 146 may support one or more features or functions on a website hosted by the third party.

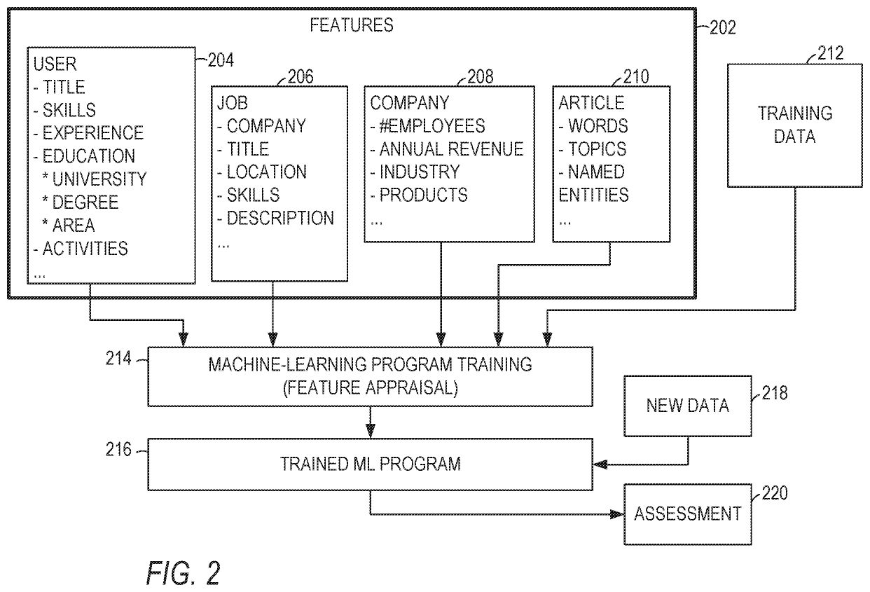

FIG. 2 illustrates the training and use of a machine-learning program, according to some example embodiments. In some example embodiments, machine-learning programs (MLP), also referred to as machine-learning algorithms or tools, are utilized to perform operations associated with searches, such as digital content (e.g., articles, jobs, etc.) searches.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 212 in order to make data-driven predictions or decisions expressed as outputs or assessments 220. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

In general, there are two types of problems in machine learning: classification problems and regression problems. Classification problems, also referred to as categorization problems, aim at classifying items into one of several category values (for example, is this object an apple or an orange?). Regression algorithms aim at quantifying some items (for example, by providing a value that is a real number). In some embodiments, example machine-learning algorithms provide a job affinity score (e.g., a number from 1 to 100) to qualify each job as a match for a member of the online service (e.g., calculating the job affinity score). In certain embodiments, example machine-learning algorithms provide a member-article affinity score (e.g., a number from 1 to 100) to qualify each article as a match for the member (e.g., calculating the job affinity score). The machine-learning algorithms utilize the training data 212 to find correlations among identified features 202 that affect the outcome.

The machine-learning algorithms utilize features for analyzing the data to generate assessments 220. A feature 202 is an individual measurable property of a phenomenon being observed. The concept of feature is related to that of an explanatory variable used in statistical techniques such as linear regression. Choosing informative, discriminating, and independent features is important for effective operation of the MLP in pattern recognition, classification, and regression. Features may be of different types, such as numeric, strings, and graphs.

In one example embodiment, the features 202 may be of different types and may include one or more of user features 204, job features 206, company features 208, and article features 210. The user features 204 may include one or more of the data in the user profile 128, as described in FIG. 1, such as title, skills, endorsements, experience, education, and the like. The job features 206 may include any data related to the job, and the company features 208 may include any data related to the company. In some example embodiments, article features 210 include word data, topic data, named entity data, and the like.

The machine-learning algorithms utilize the training data 212 to find correlations among the identified features 202 that affect the outcome or assessment 220. In some example embodiments, the training data 212 includes known data for one or more identified features 202 and one or more outcomes, such as jobs searched by users, job suggestions selected for reviews, users changing companies, users adding social connections, users' activities online, etc.

With the training data 212 and the identified features 202, the machine-learning tool is trained at operation 214. The machine-learning tool appraises the value of the features 202 as they correlate to the training data 212. The result of the training is the trained machine-learning program 216.

When the machine-learning program 216 is used to perform an assessment, new data 218 is provided as an input to the trained machine-learning program 216, and the machine-learning program 216 generates the assessment 220 as output. For example, when a user performs a job search, a machine-learning program, trained with social network data, utilizes the user data and the job data, from the jobs in the database, to search for jobs that match the user's profile and activity.

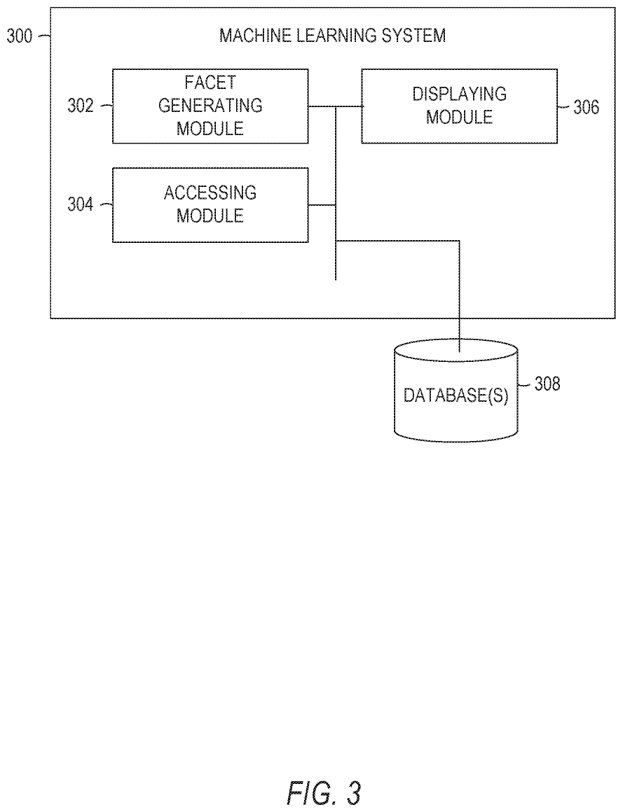

FIG. 3 is a block diagram illustrating components of the machine learning system 300, according to some example embodiments. As shown in FIG. 3, the machine learning system 300 includes a facet generating module 302, an accessing module 304, and a displaying module 306, all configured to communicate with each other (e.g., via a bus, shared memory, or a switch).

According to some example embodiments, the facet generating module 302 generates, for a user of an online system, one or more search facets using one or more machine learning algorithms. The generating of the one or more search facets is based on a user profile associated with the user and based on one or more similar user profiles identified to be similar to the user profile.

The accessing module 304 receives an identifier (e.g., one or more login credentials) of the user of the online system from a client device associated with the user. In some instances, the identifier of the user is a user's log-in credential received, by the accessing module 304, based on the user logging into the online system via the client device associated with the user.

The displaying module 306 causes a display of one or more selectable identifiers of the one or more search facets in a user interface of the client device associated with the user. The causing of the display, by the displaying module 306, of the one or more selectable identifiers of the one or more search facets may be based on the receiving of the identifier of the user by the accessing module 304.

The accessing module 304 also receives, from the client device, an indication of a selection of the one or more selectable identifiers of the one or more search facets.

The displaying module 306 also causes a display of one or more job descriptions in the user interface of the client device associated with the user based on a search performed using the one or more search facets. The causing of the display of the one or more job descriptions is performed in response to the receiving, from the client device, of the indication of the selection of the one or more selectable identifiers of the one or more search facets.

To perform one or more of its functionalities, the machine learning system 300 may communicate with one or more other systems. For example, an integration system may integrate the machine learning system 300 with one or more email servers, web servers, one or more databases, or other servers, systems, or repositories.

Any one or more of the modules described herein may be implemented using hardware (e.g., one or more processors of a machine) or a combination of hardware and software. For example, any module described herein may configure a hardware processor (e.g., among one or more hardware processors of a machine) to perform the operations described herein for that module. In some example embodiments, any one or more of the modules described herein may comprise one or more hardware processors and may be configured to perform the operations described herein. In certain example embodiments, one or more hardware processors are configured to include any one or more of the modules described herein.

Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices. The multiple machines, databases, or devices are communicatively coupled to enable communications between the multiple machines, databases, or devices. The modules themselves are communicatively coupled (e.g., via appropriate interfaces) to each other and to various data sources, so as to allow information to be passed between the applications so as to allow the applications to share and access common data. Furthermore, the modules may access one or more databases 308 (e.g., database 128, 130, 132, 136, or 138).

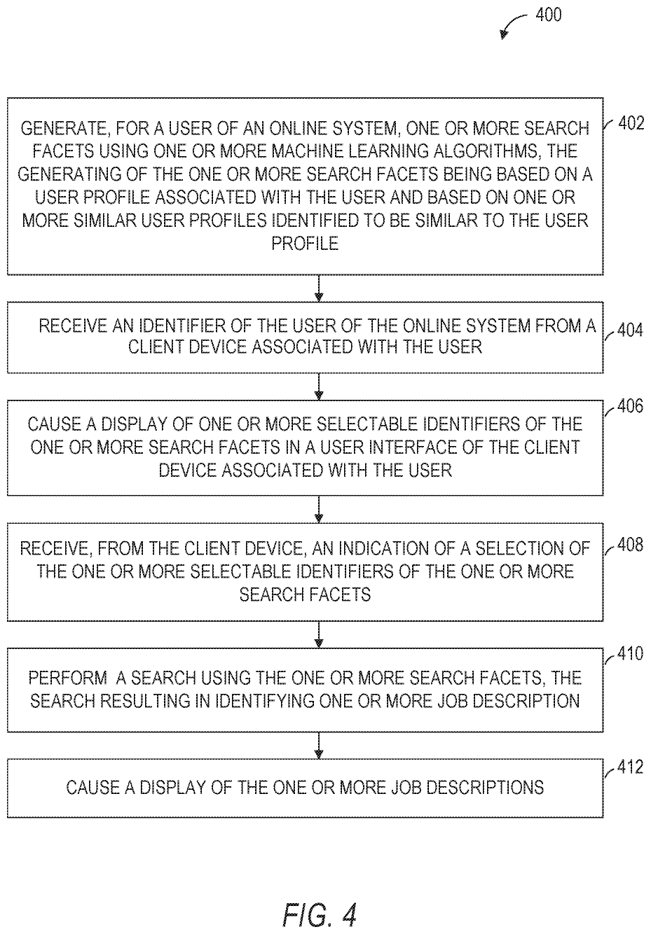

FIGS. 4-9 are flowcharts illustrating a method for personalized query formulation to improve searches, according to some example embodiments. Operations of method 400 illustrated in FIG. 4 may be performed using modules described above with respect to FIG. 3. As shown in FIG. 4, method 400 may include one or more of method operations 402, 404, 406, 408, 410, and 412 according to some example embodiments.

At operation 402, the facet generating module 302 generates, for a user of an online system, one or more search facets using one or more machine learning algorithms. The generating of the one or more search facets is based on a user profile associated with the user and based on one or more similar user profiles identified to be similar to the user profile.

At operation 404, the accessing module 304 receives an identifier (e.g., one or more login credentials) of the user of the online system from a client device associated with the user. In some instances, the identifier of the user is a user's log-in credential received, by the accessing module 304, as a result of the user logging into the online system via the client device associated with the user.

At operation 406, the displaying module 306 causes a display of one or more selectable identifiers of the one or more search facets in a user interface of the client device associated with the user. The causing of the display, by the displaying module 306, of the one or more selectable identifiers of the one or more search facets may be based on the receiving of the identifier of the user by the accessing module 304.

At operation 408, the accessing module 304 receives, from the client device, an indication of a selection of the one or more selectable identifiers of the one or more search facets.

At operation 410, the displaying module 306 performs a search using the one or more search facets. The performing of the search is responsive to receiving the indication of the selection of the one or more selectable identifiers of the one or more search facets. The search results in identifying one or more job descriptions.

At operation 412, the displaying module 306 causes a display of the one or more job descriptions. The display of the one or more job descriptions may be in the user interface of the client device associated with the user.

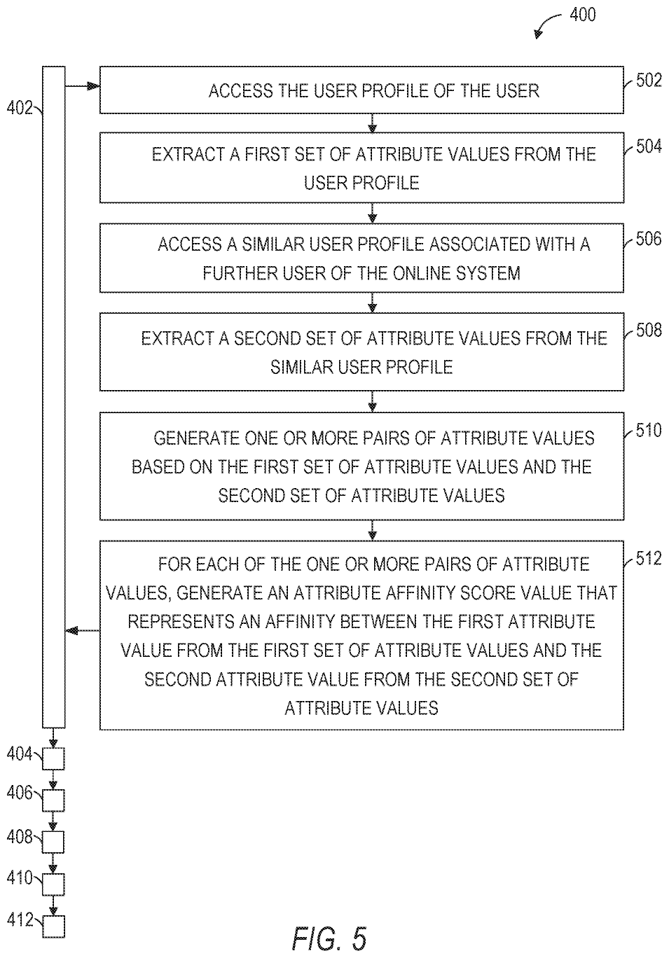

Further details with respect to the method operations of the method 400 are described below with respect to FIGS. 5-9.

As shown in FIG. 5, method 400 may include one or more of operations 502, 504, 506, 508, 510, or 512, according to some example embodiments. Operation 502 may be performed as part (e.g., a precursor task, a subroutine, or a portion) of operation 402 of FIG. 4, in which the facet generating module 302 generates, for a user of an online system, one or more search facets using one or more machine learning algorithms.

At operation 502, the facet generating module 302 accesses the user profile of the user of the online system. The user profile may be stored in and accessed from a record of a database.

At operation 504, the facet generating module 302 extracts a first set of attribute values from the user profile. An attribute value included in the first set corresponds to an attribute (e.g., a characteristic of the user, a value of a field, etc.) included in the user profile.

At operation 506, the facet generating module 302 accesses a similar user profile that is identified to be similar to the user profile of the user. The similar user profile is associated with a further user of the online system. The similar profile may be stored in and accessed from a record of a database.

At operation 508, the facet generating module 302 extracts a second set of attribute values from the similar user profile. An attribute value included in the second set corresponds to an attribute (e.g., a characteristic of the user, a value of a field, etc.) included in the similar user profile.

At operation 510, the facet generating module 302 generates one or more pairs of attribute values based on the first set of attribute values and the second set of attribute values. Each of the one or more pairs of attribute values includes a first attribute value from the first set of attribute values and a second attribute value from the second set of attribute values.

At operation 512, the facet generating module 302 generates, for each of the one or more pairs of attribute values, an attribute affinity score value that represents an affinity between the first attribute value from the first set of attribute values and the second attribute value from the second set of attribute values. A particular affinity score value is associated with the corresponding pair of attribute values.

In some example embodiments, the one or more pairs of attribute values include at least one of a pair that includes a first title from the user profile and a second title from the similar user profile, a pair that includes a first skill from the user profile and a second skill from the similar user profile, a pair that includes a first location from the user profile and a second location from the similar user profile, a pair that includes the first title from the user profile and the second skill from the similar user profile, a pair that includes the first title from the user profile and the second location from the similar user profile, a pair that includes the first skill from the user profile and the second title from the similar user profile, a pair that includes the first location from the user profile and a third skill from the similar user profile, a pair that includes the first location from the user profile and a fourth skill from the similar user profile, or a pair that includes a first organization identifier from the user profile and a second organization identifier from the similar user profile. Other pairs of attribute values are possible, according to various example embodiments.

In various example embodiments, the facet generating module 302 ranks a plurality of pairs of attribute values based on the affinity score values associated with the plurality of pairs of attribute values. The facet generating module 302 identifies one or more ranked pairs associated with one or more affinity score values that are equal to exceed an affinity threshold value. The facet generating module 302 automatically selects the one or more search facets from the identified one or more ranked pairs of attribute values. The causing of the display of the one or more selectable identifiers of the one or more search facets in the user interface is further based on the automatic selecting of the one or more search facets from the ranked one or more pairs of attribute values.

For example, the facet generating module 302 ranks, for the particular user, a plurality of pairs of attribute values based on their associated affinity score values. In some instances, the facet generating module 302 selects one or more attribute pairs that have affinity score values that are equal to or exceed a certain affinity threshold value. The facet generating module 302 then identifies, based on the selected one or more attribute pairs, one or more attributes included in the one or more attribute pairs as one or more search facets to be used in job searched for the particular user. The one or more search facets are associated with the user in a database record. Based on determining that the user has logged in to the online system, the machine learning system (e.g., the displaying module 306) may present the one or more search facets in a user interface of a client device associated with the user.

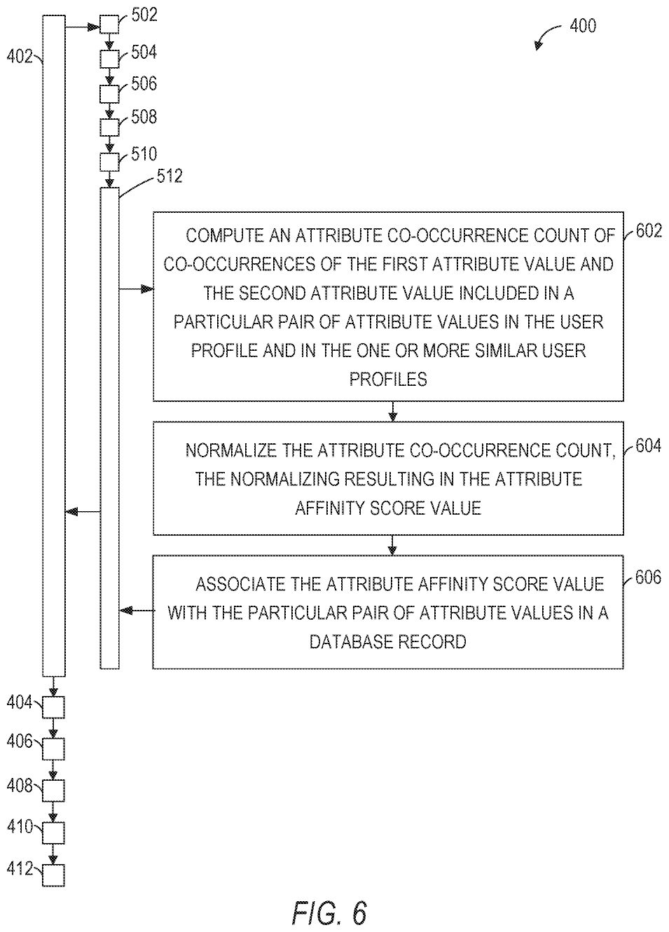

As shown in FIG. 6, the method 400 may include one or more of operations 602, 604, or 606, according to some example embodiments. Operation 602 may be performed as part (e.g., a precursor task, a subroutine, or a portion) of operation 512 of FIG. 5, in which the facet generating module 302 generates, for each of the one or more pairs of attribute values, an attribute affinity score value that represents an affinity between the first attribute value from the first set of attribute values and the second attribute value from the second set of attribute values.

At operation 602, the facet generating module 302 computes an attribute co-occurrence count of co-occurrences of the first attribute value and the second attribute value included in a particular pair of attribute values in the user profile and in the one or more similar user profiles.

At operation 604, the facet generating module 302 normalizes the attribute co-occurrence count. The normalizing results in the attribute affinity score value. The attribute affinity score value is a value between 0.00 and 1.00.

At operation 606, the facet generating module 302 associates the attribute affinity score value with a particular pair of attribute values in a database record.

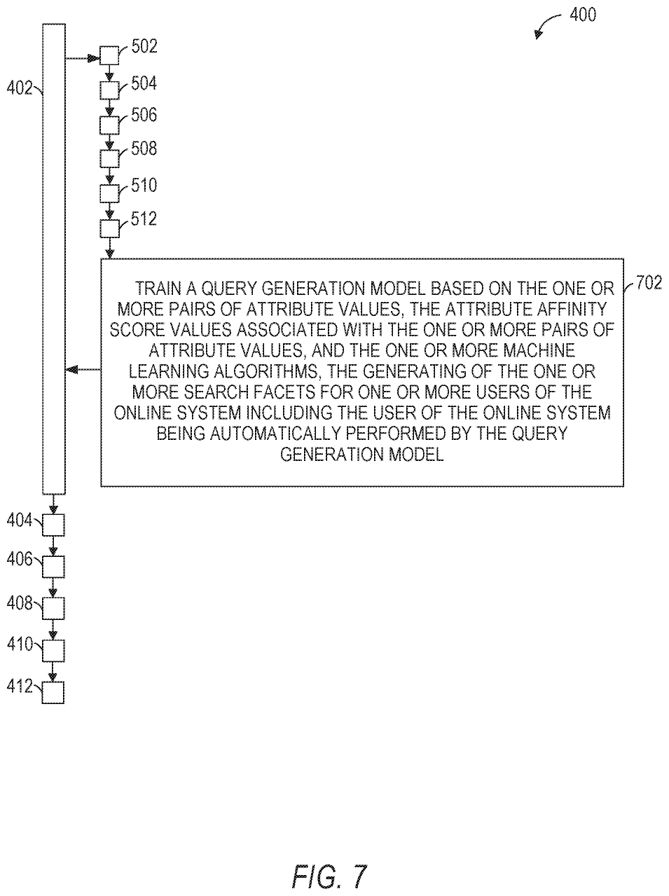

As shown in FIG. 7, the method 400 includes operation 702, according to some example embodiments. Operation 702 may be performed after operation 512 of FIG. 5, in which the facet generating module 302 generates, for each of the one or more pairs of attribute values, an attribute affinity score value that represents an affinity between the first attribute value from the first set of attribute values and the second attribute value from the second set of attribute values.

At operation 702, the facet generating module 302 trains a query generation model based on the one or more pairs of attribute values, the attribute affinity score values associated with the one or more pairs of attribute values, and the one or more machine learning algorithms. The generating of the one or more search facets for one or more users of the online system including the user of the online system is automatically performed by the query generation model.

In various example embodiments, the facet generating module 302 identifies a number of pairs of attribute values based on the attribute affinity score values associated with the number of pairs of attribute values exceeding a threshold value. The facet generating module 302 deduplicates the attribute values included in the number of pairs of attribute values. The deduplicating results in one or more unique attribute values. A particular search facet of the one or more search facets corresponds to a particular attribute value of the one or more unique attribute values. The facet generating module 302 generates the one or more selectable identifiers of the one or more search facets based on the one or more unique attribute values.

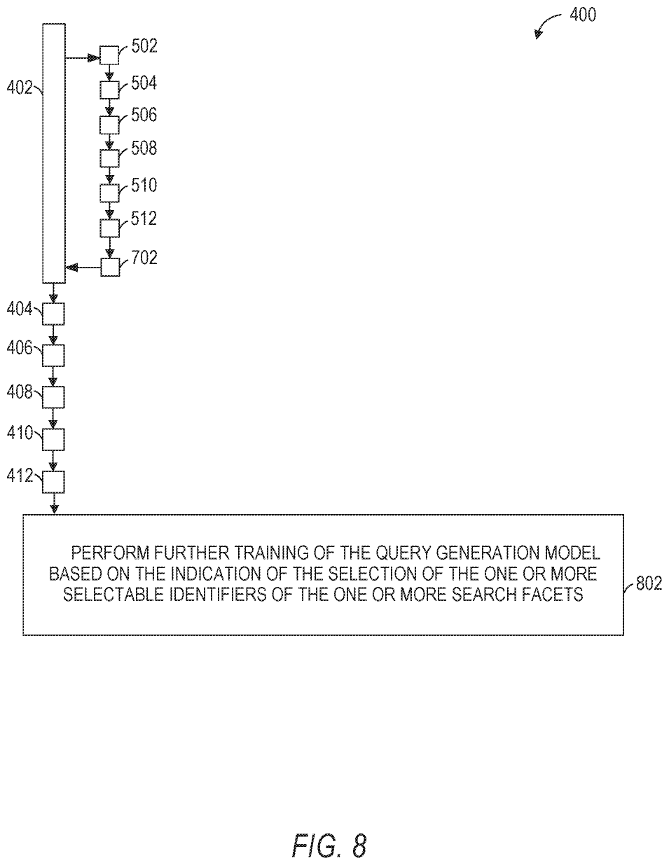

As shown in FIG. 8, the method 400 includes operation 802, according to some example embodiments. Operation 802 may be performed after operation 412 of FIG. 4, in which the displaying module 306 causes the display of the one or more job descriptions.

At operation 802, the facet generating module 302 performs further training of the query generation model based on the indication of the selection of the one or more selectable identifiers of the one or more search facets.

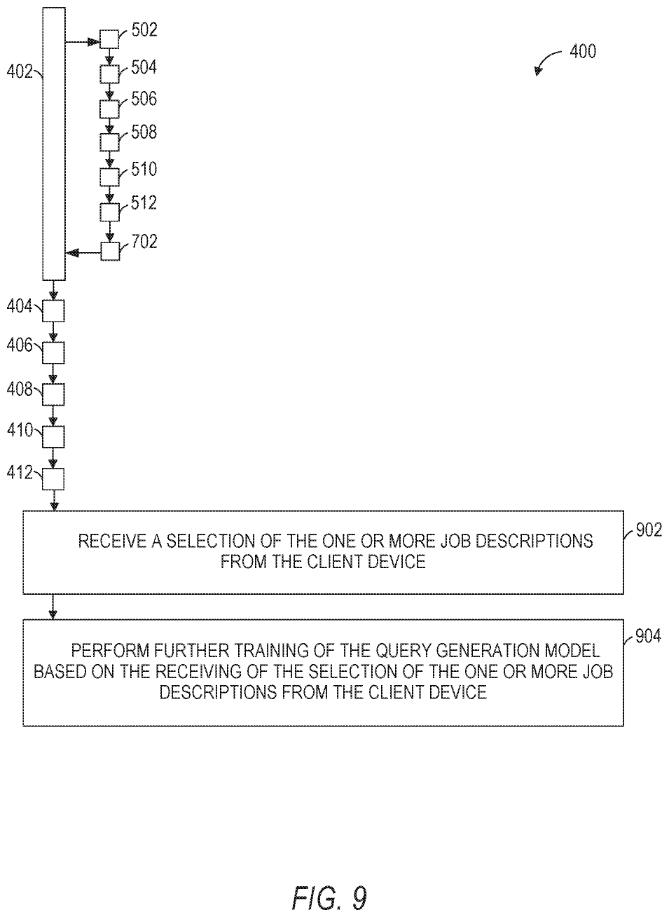

As shown in FIG. 9, method 400 may include one or more of operations 902 or 904, according to some example embodiments. Operation 902 may be performed after operation 412 of FIG. 4, in which the displaying module 306 causes the display of the one or more job descriptions.

At operation 902, the accessing module 304 receives a selection of the one or more job descriptions from the client device. The receiving of the selection of the one or more job descriptions, by the accessing module 304, may be in response to the causing of the display of the one or more job descriptions.

At operation 904, the facet generating module 302 performs further training of the query generation model based on the receiving of the selection of the one or more job descriptions from the client device.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors or processor-implemented modules, not only residing within a single machine, but deployed across a number of machines. In some example embodiments, the one or more processors or processor-implemented modules may be located in a single location (e.g., within a home environment, an office environment or as a server farm), while in other embodiments the one or more processors or processor-implemented modules may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

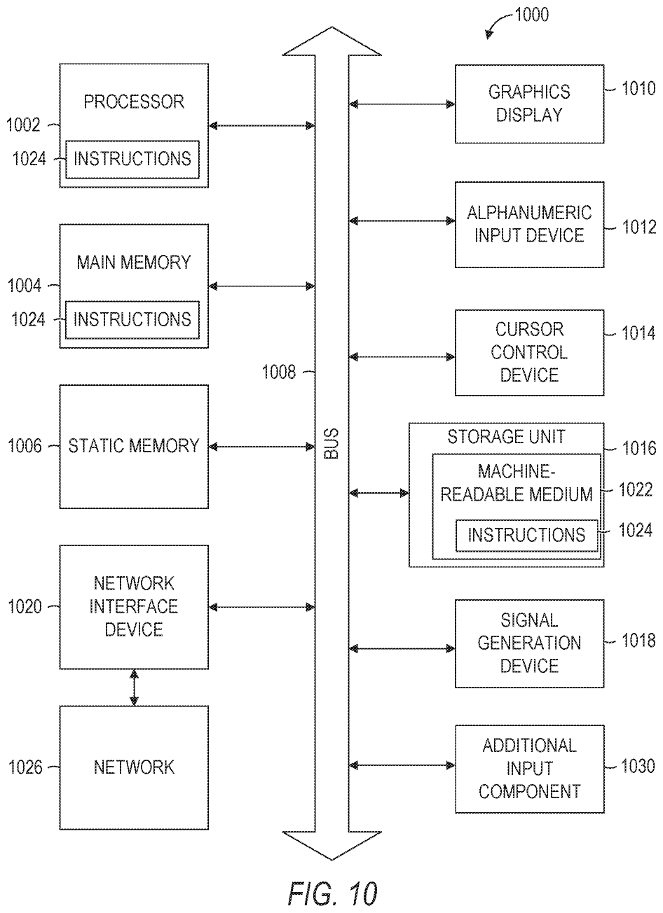

FIG. 10 is a block diagram illustrating components of a machine 1000, according to some example embodiments, able to read instructions 1024 from a machine-readable medium 1022 (e.g., a non-transitory machine-readable medium, a machine-readable storage medium, a computer-readable storage medium, or any suitable combination thereof) and perform any one or more of the methodologies discussed herein, in whole or in part. Specifically, FIG. 10 shows the machine 1000 in the example form of a computer system (e.g., a computer) within which the instructions 1024 (e.g., software, a program, an application, an applet, an app, or other executable code) for causing the machine 1000 to perform any one or more of the methodologies discussed herein may be executed, in whole or in part.

In alternative embodiments, the machine 1000 operates as a standalone device or may be connected (e.g., networked) to other machines. In a networked deployment, the machine 1000 may operate in the capacity of a server machine or a client machine in a server-client network environment, or as a peer machine in a distributed (e.g., peer-to-peer) network environment. The machine 1000 may be a server computer, a client computer, a personal computer (PC), a tablet computer, a laptop computer, a netbook, a cellular telephone, a smartphone, a set-top box (STB), a personal digital assistant (PDA), a web appliance, a network router, a network switch, a network bridge, or any machine capable of executing the instructions 1024, sequentially or otherwise, that specify actions to be taken by that machine. Further, while only a single machine is illustrated, the term “machine” shall also be taken to include any collection of machines that individually or jointly execute the instructions 1024 to perform all or part of any one or more of the methodologies discussed herein.

The machine 1000 includes a processor 1002 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1004, and a static memory 1006, which are configured to communicate with each other via a bus 1008. The processor 1002 may contain microcircuits that are configurable, temporarily or permanently, by some or all of the instructions 1024 such that the processor 1002 is configurable to perform any one or more of the methodologies described herein, in whole or in part. For example, a set of one or more microcircuits of the processor 1002 may be configurable to execute one or more modules (e.g., software modules) described herein.

The machine 1000 may further include a graphics display 1010 (e.g., a plasma display panel (PDP), a light emitting diode (LED) display, a liquid crystal display (LCD), a projector, a cathode ray tube (CRT), or any other display capable of displaying graphics or video). The machine 1000 may also include an alphanumeric input device 1012 (e.g., a keyboard or keypad), a cursor control device 1014 (e.g., a mouse, a touchpad, a trackball, a joystick, a motion sensor, an eye tracking device, or other pointing instrument), a storage unit 1016, an audio generation device 1018 (e.g., a sound card, an amplifier, a speaker, a headphone jack, or any suitable combination thereof), and a network interface device 1020.

The storage unit 1016 includes the machine-readable medium 1022 (e.g., a tangible and non-transitory machine-readable storage medium) on which are stored the instructions 1024 embodying any one or more of the methodologies or functions described herein. The instructions 1024 may also reside, completely or at least partially, within the main memory 1004, within the processor 1002 (e.g., within the processor's cache memory), or both, before or during execution thereof by the machine 1000. Accordingly, the main memory 1004 and the processor 1002 may be considered machine-readable media (e.g., tangible and non-transitory machine-readable media). The instructions 1024 may be transmitted or received over the network 1026 via the network interface device 1020. For example, the network interface device 1020 may communicate the instructions 1024 using any one or more transfer protocols (e.g., hypertext transfer protocol (HTTP)).

In some example embodiments, the machine 1000 may be a portable computing device, such as a smart phone or tablet computer, and have one or more additional input components 1030 (e.g., sensors or gauges). Examples of such input components 1030 include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1022 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing the instructions 1024 for execution by the machine 1000, such that the instructions 1024, when executed by one or more processors of the machine 1000 (e.g., processor 1002), cause the machine 1000 to perform any one or more of the methodologies described herein, in whole or in part. Accordingly, a “machine-readable medium” refers to a single storage apparatus or device, as well as cloud-based storage systems or storage networks that include multiple storage apparatus or devices. The term “machine-readable medium” shall accordingly be taken to include, but not be limited to, one or more tangible (e.g., non-transitory) data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute software modules (e.g., code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software (e.g., a software module) may accordingly configure one or more processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The performance of certain operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
generating, for a user of an online system, one or more search facets using one or more machine learning algorithms, the generating of the one or more search facets being based on a user profile associated with the user and based on one or more similar user profiles identified to be similar to the user profile, the generating of the one or more search facets being performed using one or more hardware processors;
receiving an identifier of the user of the online system from a client device associated with the user;
based on the receiving of the identifier of the user, causing a display of one or more selectable identifiers of the one or more search facets in a user interface of the client device associated with the user;
receiving, from the client device, an indication of a selection of the one or more selectable identifiers of the one or more search facets;
responsive to receiving the indication of the selection of the one or more selectable identifiers of the one or more search facets, performing a search using the one or more search facets, the search resulting in identifying one or more job descriptions; and
causing a display of the one or more job descriptions.

2. The method of claim 1, wherein the generating of the one or more search facets includes:
accessing the user profile of the user of the online system;
extracting a first set of attribute values from the user profile, an attribute value included in the first set corresponding to an attribute included in the user profile;
accessing a similar user profile that is identified to be similar to the user profile of the user, the similar user profile being associated with a further user of the online system;
extracting a second set of attribute values from the similar user profile, an attribute value included in the second set corresponding to an attribute included in the similar user profile;
generating one or more pairs of attribute values based on the first set of attribute values and the second set of attribute values, wherein each of the one or more pairs of attribute values includes a first attribute value from the first set of attribute values and a second attribute value from the second set of attribute values; and
for each of the one or more pairs of attribute values, generating an attribute affinity score value that represents an affinity between the first attribute value from the first set of attribute values and the second attribute value from the second set of attribute values.

3. The method of claim 2, further comprising:
ranking a plurality of pairs of attribute values based on the affinity score values associated with the plurality of pairs of attribute values;
identifying one or more ranked pairs associated with one or more affinity score values that are equal to exceed an affinity threshold value;
automatically selecting the one or more search facets from the identified one or more ranked pairs of attribute values,
wherein the causing of the display of the one or more selectable identifiers of the one or more search facets in the user interface is further based on the automatic selecting of the one or more search facets from the ranked one or more pairs of attribute values.

4. The method of claim 2, wherein the one or more pairs of attribute values include at least one of a pair that includes a first title from the user profile and a second title from the similar user profile, a pair that includes a first skill from the user profile and a second skill from the similar user profile, a pair that includes a first location from the user profile and a second location from the similar user profile, a pair that includes the first title from the user profile and the second skill from the similar user profile, a pair that includes the first title from the user profile and the second location from the similar user profile, a pair that includes the first skill from the user profile and the second title from the similar user profile, a pair that includes the first location from the user profile and a third skill from the similar user profile, a pair that includes the first location from the user profile and a fourth skill from the similar user profile, or a pair that includes a first organization identifier from the user profile and a second organization identifier from the similar user profile.

5. The method of claim 2, wherein the generating of the attribute affinity score value includes:
computing an attribute co-occurrence count of co-occurrences of the first attribute value and the second attribute value included in a particular pair of attribute values in the user profile and in the one or more similar user profiles;
normalizing the attribute co-occurrence count, the normalizing resulting in the attribute affinity score value; and
associating the attribute affinity score value with the particular pair of attribute values in a database record.

6. The method of claim 2, further comprising:
training a query generation model based on the one or more pairs of attribute values, the attribute affinity score values associated with the one or more pairs of attribute values, and the one or more machine learning algorithms,
wherein the generating of the one or more search facets for one or more users of the online system including the user of the online system is automatically performed by the query generation model.

7. The method of claim 6, further comprising:
identifying a number of pairs of attribute values based on the attribute affinity score values associated with the number of pairs of attribute values exceeding a threshold value; and
deduplicating the attribute values included in the number of pairs of attribute values, the deduplicating resulting in one or more unique attribute values,
wherein a particular search facet of the one or more search facets corresponds to a particular attribute value of the one or more unique attribute values,
wherein the method further comprises:
generating the one or more selectable identifiers of the one or more search facets based on the one or more unique attribute values.

8. The method of claim 6, further comprising:
performing further training of the query generation model based on the indication of the selection of the one or more selectable identifiers of the one or more search facets.

9. The method of claim 6, further comprising:
in response to the causing of the display of the one or more job descriptions, receiving a selection of the one or more job descriptions from the client device; and
performing further training of the query generation model based on the receiving of the selection of the one or more job descriptions from the client device.

10. A system comprising:
one or more hardware processors; and
a non-transitory machine-readable medium for storing instructions that, when executed by the one or more hardware processors, cause the one or more hardware processors to perform operations comprising:
generating, for a user of an online system, one or more search facets using one or more machine learning algorithms, the generating of the one or more search facets being based on a user profile associated with the user and based on one or more similar user profiles identified to be similar to the user profile;
receiving an identifier of the user of the online system from a client device associated with the user;
based on the receiving of the identifier of the user, causing a display of one or more selectable identifiers of the one or more search facets in a user interface of the client device associated with the user;
receiving, from the client device, an indication of a selection of the one or more selectable identifiers of the one or more search facets;
responsive to receiving the indication of the selection of the one or more selectable identifiers of the one or more search facets, performing a search using the one or more search facets, the search resulting in identifying one or more job descriptions; and
causing a display of the one or more job descriptions.

11. The system of claim 10, wherein the generating of the one or more search facets includes:
accessing the user profile of the user of the online system;
extracting a first set of attribute values from the user profile, an attribute value included in the first set corresponding to an attribute included in the user profile;
accessing a similar user profile that is identified to be similar to the user profile of the user, the similar user profile being associated with a further user of the online system;
extracting a second set of attribute values from the similar user profile, an attribute value included in the second set corresponding to an attribute included in the similar user profile;
generating one or more pairs of attribute values based on the first set of attribute values and the second set of attribute values, wherein each of the one or more pairs of attribute values includes a first attribute value from the first set of attribute values and a second attribute value from the second set of attribute values; and
for each of the one or more pairs of attribute values, generating an attribute affinity score value that represents an affinity between the first attribute value from the first set of attribute values and the second attribute value from the second set of attribute values, the attribute affinity score value being associated with a particular pair of the one or more attribute values.

12. The system of claim 11, wherein the one or more pairs of attribute values include at least one of a pair that includes a first title from the user profile and a second title from the similar user profile, a pair that includes a first skill from the user profile and a second skill from the similar user profile, a pair that includes a first location from the user profile and a second location from the similar user profile, a pair that includes the first title from the user profile and the second skill from the similar user profile, a pair that includes the first title from the user profile and the second location from the similar user profile, a pair that includes the first skill from the user profile and the second title from the similar user profile, a pair that includes the first location from the user profile and a third skill from the similar user profile, a pair that includes the first location from the user profile and a fourth skill from the similar user profile, or a pair that includes a first organization identifier from the user profile and a second organization identifier from the similar user profile.

13. The system of claim 11, wherein the generating of the attribute affinity score value includes:
computing an attribute co-occurrence count of co-occurrences of the first attribute value and the second attribute value included in a particular pair of attribute values in the user profile and in the one or more similar user profiles;
normalizing the attribute co-occurrence count, the normalizing resulting in the attribute affinity score value; and
associating the attribute affinity score value with the particular pair of attribute values in a database record.

14. The system of claim 11, wherein the operations further comprise:
training a query generation model based on the one or more pairs of attribute values, the attribute affinity score values associated with the one or more pairs of attribute values, and the one or more machine learning algorithms, the query generation model automatically generating the one or more search facets for one or more users of the online system including the user of the online system.

15. The system of claim 14, wherein the operations further comprise:
identifying a number of pairs of attribute values based on the attribute affinity score values associated with the number of pairs of attribute values exceeding a threshold value; and
deduplicating the attribute values included in the number of pairs of attribute values, the deduplicating resulting in one or more unique attribute values,
wherein a particular search facet of the one or more search facets corresponds to a particular attribute value of the one or more unique attribute values,
wherein the operations further comprise:
generating the one or more selectable identifiers of the one or more search facets based on the one or more unique attribute values.

16. The system of claim 14, wherein the operations further comprise:
performing further training of the query generation model based on the indication of the selection of the one or more selectable identifiers of the one or more search facets.

17. The system of claim 14, wherein the operations further comprise:
in response to the causing of the display of the one or more job descriptions, receiving a selection of the one or more job descriptions from the client device; and
performing further training of the query generation model based on the receiving of the selection of the one or more job descriptions from the client device.

18. A non-transitory machine-readable medium for storing instructions that, when executed by one or more hardware processors, cause the one or more hardware processors to perform operations comprising:
generating, for a user of an online system, one or more search facets using one or more machine learning algorithms, the generating of the one or more search facets being based on a user profile associated with the user and based on one or more similar user profiles identified to be similar to the user profile;
receiving an identifier of the user of the online system from a client device associated with the user;
based on the receiving of the identifier of the user, causing a display of one or more selectable identifiers of the one or more search facets in a user interface of the client device associated with the user;
receiving, from the client device, an indication of a selection of the one or more selectable identifiers of the one or more search facets;
responsive to receiving the indication of the selection of the one or more selectable identifiers of the one or more search facets, performing a search using the one or more search facets, the search resulting in identifying one or more job descriptions; and
causing a display of the one or more job descriptions.

19. The non-transitory machine-readable medium of claim 18, wherein the generating of the one or more search facets includes:
accessing the user profile of the user of the online system;
extracting a first set of attribute values from the user profile, an attribute value included in the first set corresponding to an attribute included in the user profile;
accessing a similar user profile that is identified to be similar to the user profile of the user, the similar user profile being associated with a further user of the online system;
extracting a second set of attribute values from the similar user profile, an attribute value included in the second set corresponding to an attribute included in the similar user profile;
generating one or more pairs of attribute values based on the first set of attribute values and the second set of attribute values, wherein each of the one or more pairs of attribute values includes a first attribute value from the first set of attribute values and a second attribute value from the second set of attribute values; and
for each of the one or more pairs of attribute values, generating an attribute affinity score value that represents an affinity between the first attribute value from the first set of attribute values and the second attribute value from the second set of attribute values, the attribute affinity score value being associated with a particular pair of the one or more attribute values.

20. The non-transitory machine-readable medium of claim 19, wherein the generating of the attribute affinity score value includes:
computing an attribute co-occurrence count of co-occurrences of the first attribute value and the second attribute value included in a particular pair of attribute values in the user profile and in the one or more similar user profiles;
normalizing the attribute co-occurrence count, the normalizing resulting in the attribute affinity score value; and
associating the attribute affinity score value with the particular pair of attribute values in a database record.
